(19) United States
(12) Patent Application Publication
(10) Pub. No.: US 2010/0076940 A1
(43) Pub. Date: Mar. 25, 2010

(54) METHOD FOR PROVIDING MAXIMAL CONCURRENCY IN A TREE STRUCTURE

(75) Inventors: Rajesh Ramkrishna Bordawekar, Yorktown Heights, NY (US); John Eliot Moss, Amherst, MA (US)

Correspondence Address: Ryan, Mason & Lewis, LLP;Suite 205, 1300 Post Road, Fairfield, CT, 06824, US

(73) Assignees: International Business Machines Corporation, Armonk, NY (US); The University of Massachusetts, Boston, MA (US)

(21) Appl. No.: 12/206,817

(22) Filed: Sep. 9, 2008

(51) Int. Cl. G06F 17/30

(52) U.S. Cl. 707/704; 707/E17.002; 707/E17.007

(57) ABSTRACT

Techniques for providing maximal concurrency while ensuring no deadlock in a tree structure are provided. The techniques include accessing a minimum number of one or more nodes to perform an operation.

### FIELD OF THE INVENTION

The present invention generally relates to information technology, and, more particularly, to B-trees.

### BACKGROUND OF THE INVENTION

B-trees are a fundamental data structure and are significant because of their O(logn) behavior for lookup, insert, delete, find next higher key, etc. They are also used for indexing in database systems.

The emergence of commodity parallelism makes concurrent B-trees of interest for a variety of other software. Concurrent use of a B-tree requires that one control access to nodes, typically using locks. One proceeds from the root of the tree toward the leaves, locking individual nodes along the way. To gain a more stable view of the tree and stronger invariants, one can use a locking protocol such as lock coupling. In such a protocol, to move from an already locked node A to a child node B, one first locks B and only then releases the lock on A. This has the effect of preserving operation order along any given path in the tree and is deadlock-free because it always locks a parent before a child. However, one cannot implement lock coupling using atomic blocks because the periods of time A and B that are locked are neither independent nor properly nested.

A concern that highly concurrent implementations face is how long a given node may be locked. Typical descriptions of B-tree algorithms use an elegant recursive style, not only for searching but also for handling node splits and deletions, etc. In such a style, if a node might possibly split (or become under-full, etc.) one must lock the node for the duration of operation on the sub-tree under the node. This can seriously restrict parallelism.

As is the case when searching without lock coupling, here the world also can have changed significantly between the time one requests a structure modifying operation (SMO) and the time that it occurs. For example, if a node splits, the proper parent-level node into which to insert the new node may not be the parent that one encountered on the way down the tree. Also, since the new node may exist for some time at its level before it will appear at the parent level, searching and other operations must work without exact information from the parent level.

One can broadly classify concurrent B-tree algorithms by the underlying locking schemes and structural enhancements to the basic B-tree data structure. Also, one can characterize the locking schemes by lock access type (shared, exclusive, and their intentional versions), duration (locks or latches), direction (top-down vs. bottom-up), scope (hierarchical vs. single node), and policy (pessimistic, optimistic, and two-phase locking).

### SUMMARY OF THE INVENTION

Principles of the present invention provide techniques for providing maximal concurrency in a tree structure. An exemplary method (which may be computer-implemented) for providing maximal concurrency while ensuring no deadlock in a tree structure, according to one aspect of the invention, can include accessing a minimum number of one or more nodes to perform an operation.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus or system including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a B^{link} tree node, according to an embodiment of the present invention;

FIG. 2 is a diagram illustrating a B^{link} tree with a split in progress, according to an embodiment of the present invention;

FIG. 3 is a diagram illustrating an insertion operation, according to an embodiment of the present invention;

FIG. 4 is a diagram illustrating a deletion operation, according to an embodiment of the present invention;

FIG. 5 is a diagram illustrating ticket sequencing for FIG. 4, according to an embodiment of the present invention;

FIG. 6 is a diagram illustrating granularities of atomic blocks, according to an embodiment of the present invention;

FIG. 7 is a diagram illustrating the delete operation, on a concurrent B-link tree, according to an embodiment of the present invention;

FIG. 8 is a diagram illustrating the use of cursors in a concurrent B-link tree, according to an embodiment of the present invention;

FIG. 9 is a flow diagram illustrating techniques for providing maximal concurrency while ensuring no deadlock in a tree structure, according to an embodiment of the present invention; and

FIG. 10 is a system diagram of an exemplary computer system on which at least one embodiment of the present invention can be implemented.

### DETAILED DESCRIPTION OF PREFERRED EMBODIMENTS

Principles of the present invention include highly concurrent B-trees using atomic blocks. Also, one or more embodiments of the invention include a highly-concurrent B-link tree with deferred asynchronous structural updates and cursor-based navigation. In contrast to disadvantageous existing approaches, the techniques described herein support highly-concurrent operation on B-tree to enable non-nested optimistic concurrency.

In one or more embodiments of the invention, one can release the lock on A before acquiring the lock on B, which substantially relaxes what one can assume about the state of the world when one arrives at B. One can use, for example, atomic blocks because of their software engineering advantage of clearly delimiting the scope of protected access to a node. Using atomic blocks can also facilitate checking that a code is deadlock-free. In particular, whenever one nests the blocks, one can choose to lock only nodes at the same level of the tree, and only in left-to-right order.

One or more embodiments of the invention defer structure modifying operations (SMOs). For concurrency and to avoid deadlock, one can run the SMOs as separate operations, occurring after the primary operation that the user requested. One can perform SMOs synchronously, that is, by the user thread at the end of the user operation (before returning to the application), or asynchronously, by some extra worker thread at an arbitrary later time.

In an illustrative embodiment of the invention, one can think of the interior of the tree as a helpful cache to get one near the desired leaf, rather than a definitive index (though in an idle tree it will be definitive).

User code often requests a series of accesses that have locality in the B-tree, notably sequential scans. Therefore, one or more embodiments of the invention support cursors, which cache information about nodes encountered on a previous search and reduce the need to search from the root each time. The general pattern of access via a cursor involves accessing a leaf node, then nodes at succeeding higher levels until finding one whose range includes the search key, and proceeding back down the tree from there. This could lead to deadlock in classical implementations, but because the techniques described herein access each level separately, there is no problem.

As described herein, one or more embodiments of the invention include a B-tree design that offers a very high degree of concurrency, controls concurrency with atomic blocks, supports various granularities of locking, supports cursors, and allows asynchronous processing of deferred structure updates. Also, in contrast to the disadvantageous existing approaches, the techniques described herein use atomic actions for all operations, give details for ordering SMOs, support cursors and offer several lock granularities.

As detailed herein, B-trees are a familiar structure, but can possess several variants. An exemplary organization used herein can have features such as, for example, all user key-value pairs are stored in the leaves, with keys and values in interior nodes serving only an indexing function (this can be referred to as a B+-tree), and every node has a pointer to its right sibling (this can be referred to as a Blink tree). Such properties facilitate insertion and deletion in that one is not presented with the case of deleting a separator key in an interior node, etc. Such properties can also help with sequential access in the leaves. One can apply it to good effect at all levels to assist navigation in the face of asynchronous updates to different levels of the tree.

One or more embodiments of the invention use a B-tree as a general index, which may permit storing multiple values associated with the same key. Also, one can easily restrict any given tree to permit only single values. This leads to the following set of basic operations:

Create( ), which creates a new, empty B-tree;

Fetch(key, value), which searches for the key-value pair. It returns the pair if it is present, or null otherwise. Value may be −∞, which requests the lowest pair for that key, or +∞, which requests the highest. Key may be −∞, which requests the lowest key in the tree, or +∞, which requests the highest;

FetchNext(key, value), which finds the next higher key-value pair and returns it, or null if there is not a higher pair. Value may be −∞ to find the lowest pair with a key at least as high as the argument key, and may be +∞ to find the lowest pair for the next higher key;

Insert(key, value), which inserts the key-value pair; and

Delete(key, value), which deletes the key-value pair. Value may be −∞ to delete the lowest pair for the given key.

One can develop a number of minor variations concerning what happens if one attempts to insert a key that is present, to delete a key that is absent, etc. One can also implement reverse scanning (FetchPrevious), though it is not strictly symmetrical to implement because one can link nodes in only one direction. Linking in one direction reduces the number of nodes affected by structural changes (node insertion and deletion), and is generally preferable to bi-directional linking.

In one or more embodiments of the invention, each B-tree node can include the following data:

n, the number of key-value pairs in the node;

pairᵢ, the ith key-value pair, for 1≦i≦n. The pairs are in increasing lexicographic order. Note that because one can support multiple values associated with the same key, one needs both keys and values in interior nodes to split long runs of values associated with the same key;

min, max, pairs that define the range of pairs allowed in the node. For each pair pi, min≦pi<max. Also, a node's max equals its right sibling's min. The min of the leftmost node of a level is [symbol] −∞,−∞ [symbol] , and the max of the rightmost node is [symbol] +∞,+∞ [symbol] . Neither min nor max need be a pair present in the tree. One can interpret pair₀ as meaning min and pairₙ₊₁ as max;

childᵢ, present in interior nodes only, the ith child of this node, for 0≦i≦n. Normally, every pair p in the child's sub-tree obeys pairi≦p<pairᵢ+1. One can later relax that property to allow deferred updates of interior nodes;

next, pointer to the right sibling; null if at right end;

level, the level of the node, 0 for leaves, 1 for their parents, etc.;

state, the state of node; any of several values (beingAdded, present, beingDeleted, deleted, unlinked, and de-rooted), which indicate the stage of adding or deleting node;

One can also add more fields related to handling concurrency and supporting cursors. Additionally, notice that there are no back pointers from child nodes to their parents. FIG. 1 is a diagram illustrating a B^{link} tree node 102, according to an embodiment of the present invention. By way of illustration, FIG. 1 depicts the primary fields of a node.

The B-tree itself can include, for example, a pointer cell referring to the root node of the tree. One can update this cell when the tree changes in height. For a tree of order k, normally each node except for the root will contain at least [k/2] pairs, and can never contain more than k pairs. The root node can contain as few as 0 pairs (for an empty tree).

One or more embodiments of the invention specify atomic access according to regions of code, similar to synchronized methods or synchronized blocks in Java, or atomic blocks as proposed elsewhere. As such, one can easily generate an implementation based either on locks or on transactional memory. To facilitate this, a region specifies an object and a locking mode. The modes can be, for example, S (shared) and X (exclusive).

When entering an atomic region, one acquires the designated object in the designated mode. Only one thread at a time may acquire a given object in X mode. Multiple threads may acquire an object in S mode, but not at the same time as any thread in X mode. When a thread has acquired an object in X mode, it may read and write fields of the object. In S mode, it is limited to reading fields of the object. To avoid deadlock, one can choose to not allow a thread to upgrade its lock on a given object by nesting an X mode region within an S mode region for that object. One may nest an S region in an X region, but it does not downgrade the lock. Exiting a region (by completing execution, returning from within it, throwing an exception, etc.) releases the corresponding lock on the acquired object, reverting the acquisition state to what it was before entering the region (which may be no different).

For a given nest of regions, all writes must occur logically after the first acquisition in X mode and before the last X mode release, and all reads must occur logically after the first acquisition (in any mode) and before the last release. Further, execution must be consistent with a single total order of execution of regions, and with the order of execution of regions by each thread.

One or more embodiments of the invention include coarse- and medium-grained schemes that lock one object to gain S or X mode access to any or all of a clearly specified set of objects. In particular, they can lock the B-tree object (not the root node, but the cell referring to it, because the root node may change) to gain S or X mode access to levels of the tree above a statically determined threshold. One can use fine-grained access for levels below the threshold.

With respect to B-tree design, one or more embodiments of the invention break the large operation down into smaller steps, weakening the structural invariants of the tree in order to improve concurrency. Also, one or more embodiments of the invention maintain a strong invariant for each level of the tree. The nodes of a level exactly partition the key-value space from [symbol] −∞,−∞ [symbol] to [symbol] +∞,+∞ [symbol] , with the max of each node equaling the min of its right neighbor. The pairs of each node lie within the node's range and are stored in order. Additionally, one or more embodiments of the invention maintain the next links, and any update to a node preserves these invariants.

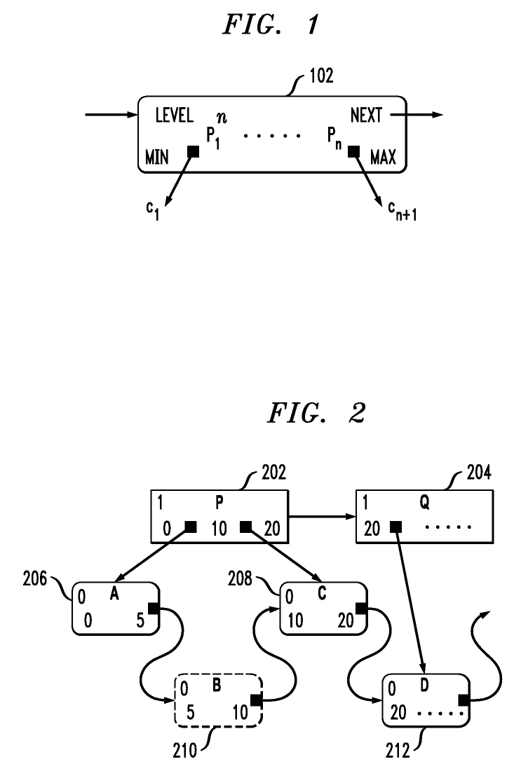

One can relax those invariants that connect levels. For example, a child pointer may refer to a node whose min is lower than what the parent has recorded as the child's min (and likewise for max). Thus, a search must sometimes proceed to the right at the same level, as opposed to down towards the leaves. This relaxed parent-child invariant matches with uni-directional links (as described herein) at each level, which allow immediate access from each node to the same-level node with the next higher set of keys/values. FIG. 2 shows one example situation. FIG. 2 is a diagram illustrating a B^{link} tree with a split in progress, according to an embodiment of the present invention. By way of illustration, FIG. 2 depicts node P 202, node Q 204, node A 206, node C 208, node B 210 and node D 212.

For example, in FIG. 2, searching for key 7 will proceed down from node P 202 to node A 206, and then right from A 206 to B 210. The search is perceiving the state between the split of A 206 at the leaf level and the insertion of B 210 at the parent level.

One or more embodiments of the invention can introduce a new invariant that once a node becomes empty, it remains empty. This does not apply to a leaf node whose range includes all keys, that is, the node representing a one-level tree.

Also, one or more embodiments of the invention include pseudo-code for searching for a given key value pair at a given level of the tree. The special keys and/or values −∞ and +∞ are readily handled by the within-node search procedures.

```
  Node Search (int level, Pair pr): // assumes level ≧ 0
  Node curr;
  Node next = root;
  Node result = null;
  while (result == null)
    curr = next;
  atomic (curr, S)
    if (pr does not lie in range of curr)
    // by invariant, must be to the right
    next = curr.next;
  else if (curr. level > level + 1)
    // need to descend to next level
    next = child whose range we think contains pr;
  else if (curr. level == level + 1)
    // we are one level above desired level
    result = child whose range we think contains pr;
  else
    // we are the appropriate node (short tree)
    result = curr;
return result;
```

A search procedure can use higher levels of a tree to find, relatively quickly, a good starting point for obtaining the node on which one desires to operate. Because of asynchrony, the desired node may actually be to the right of the node returned by the search, so a fundamental operation at a given level proceeds using the following pattern:

Result ApplyOp (Node start, Pair pr, Mode m):

```
Node curr;
Node next = start;
Result res;
while (next ! = null)
  curr = next;
atomic (curr, m) // m is the locking mode Op needs
  if (pr lies in range of curr)
    res = perform Op;
    next = null;
  else
    next = curr.next;
return res;
```

If one abandons the discipline of strictly matching acquire and/or release pairs, one could write a simpler searching routine that would find the desired node, lock it in the requested mode, and return it. Another way to avoid writing the pattern repeatedly (once for each operation) is to write a single search routine that takes a handle on an operation (for example, a function pointer in C) and its arguments, that is, essentially a closure. The routine does the search and applies the operation, so the ApplyOp pattern appears only once. Notice that in between executions of the atomic block, node ranges can change. However, the proper node always lies to the right.

If the B-tree is balanced (as it should be by definition), and its levels are up to date with respect to each other, then a search from the root visits O(logn) nodes for a tree containing,i key-value pairs. If there are k deferred structure-modifying operations (SMOs), then a parent node may omit up to k child pointers. As such, a traversing thread may need to make up to k moves to the right in the tree, without moving down. To maintain a bound of O(logn) time for traversing a tree, one needs to bound k so that it also is O(logn). This can be accomplished, for example, by using semaphore-style synchronization for performing SMOs, that is, a semaphore that, when idle, has a value N that is O(logn), and on which a thread must perform a P before requesting an SMO, and a V after updating the parent level.

In a system with high concurrency, any given thread can be continually overtaken as it traverses toward a target leaf node. The overtaking threads can perform inserts in leaves and force continual splits. The semaphore synchronization controls only the number of simultaneously outstanding SMOs, but not the total number of SMOs that can occur in between times that such a thread makes progress. This issue exists in lock coupling implementations as well, if they support overtaking, as the parent has out-of-date boundary key information, so the thread goes to the “wrong” child. As such, it may need to traverse to the right. Other threads, however, can insert rapidly and push the thread's target key farther and farther right.

One or more embodiments of the invention impose a fairly strong global fairness-of-progress guarantee, namely that operations started against the tree earlier will eventually beat all new operations in making progress. One mechanism, for example, is to distribute sequentially numbered tickets as operations begin, and to hold back new operations if the oldest incomplete operation is more than O(logn) tickets ago. As such, the techniques described herein insure that the degree of concurrency in our experiments does not exceed the number of hardware threads available, thus reducing the likelihood of long periods of thread inactivity because of de-scheduling, which would make threads vulnerable to this kind of starvation.

Implementing a fetch is straightforward given Search and ApplyOp: either the desired pair is present or it is not, and the techniques described herein return the appropriate result, as shown in FetchCore below (which would be invoked where Op is called in ApplyOp).

Pair FetchCore (Node curr, Pair pr):

```
// by design pr is in curr's range
// and curr is acquired in S mode
if (pr in curr)
  return pr;
else
  return null;
```

FetchNext is also straightforward, but requires a custom version of ApplyOp, shown as FetchNextOp below. The custom version is required because the input pair for FetchNext may be the last pair in a node (or beyond it), forcing FetchNext to examine nodes to the right. In this case, FetchNextOp must lock both nodes to insure that no pair is inserted between pr and res. Also, it must skip any intervening empty nodes (one can guarantee that such nodes will remain empty).

Pair FetchNextOp (Node start, Pair pr):

```
Node curr;
Node next = start;
Pair res = null;
while (next ! = null)
  curr = next;
  atomic (curr, S)
    next = curr.next;
    if (pr is not in range of curr)
      continue;
    else if (curr has a pair > pr)
      res = the smallest such pair;
      next = null;
    else // find next non.empty node
      Node succ;
      while (next ! = null)
        succ = next;
        atomic (succ, S)
          next = succ.next;
          if (succ has pairs)
            res = smallest pair of succ;
            next = null;
return res;
```

Fetching the first and last pairs of the entire tree are slightly special cases, but offer no difficulty.

Except for the case of a node that is full, Insert is also straightforward. However, one should obey the range of pairs allowed in a node. If the pair being inserted comes after all pairs currently in the node and the node has room, one might think it is all right to insert the pair in the node. But if the pair does not lie in the node's assigned range, one must proceed to the right. This situation would not arise in a non-concurrent B-tree, nor in one that maintained strict consistency of boundary key information across levels. But using deferred SMOs implies that some insertions may arrive at the “wrong” node, to the left of where they should be. If one fails to obey the nodes' assigned range information, one can end up inserting pairs out of order.

Consider the possibility that the proper node to receive the new pair is full. As expected, one could split the node, inserting a new right sibling that receives the higher half of the pairs. One determines a boundary pair value h that separates the two groups of pairs, and sets the left (original) node's range to end at b and the right node's range to start at b and ends where the original node previously ended.

```
boolean InsertCore (Node curr, Pair pr):
  // by design pr is in curr's range,
  // and curr is acquired in X mode
  if (pr in curr) // no change required
    return false;
  else if (pr fits in curr)
    insert pr;
    return true;
  // overflow: rebalance or split
  // this is the place to attempt rebalancing if desired
  Node fresh = a new node; fresh.state = beingAdded;
  balance old pairs plus pr between curr and fresh, with fresh getting the
higher pairs;
  // insert fresh on same.level linked list of nodes
  fresh.next = curr.next; curr.next = fresh;
  // adjust node ranges
  fresh.max = curr.max;
  Pair bnd = smallest pair of fresh;
  curr.max = fresh.min = bnd;
  // request a deferred SMO
  request InsertSMO(curr.level + 1, curr.min, curr, bnd, fresh);
  return true;
```

At this point, the insertion is complete at the leaf level. One can then perform, as a separate operation on the tree, an SMO to insert the boundary pair bnd and the new node into the parent level. Note that the node at the parent level that was traversed to get to the leaf that we split may not have been, or may no longer be, the parent of the split node. That is why one or more embodiments of the invention insert the pair and node into the parent level. That insertion proceeds analogously to inserting a pair into a leaf. If the insertion at the parent level causes a split, one can perform yet another separate SMO to insert the new parent-level node into the grandparent level, etc.

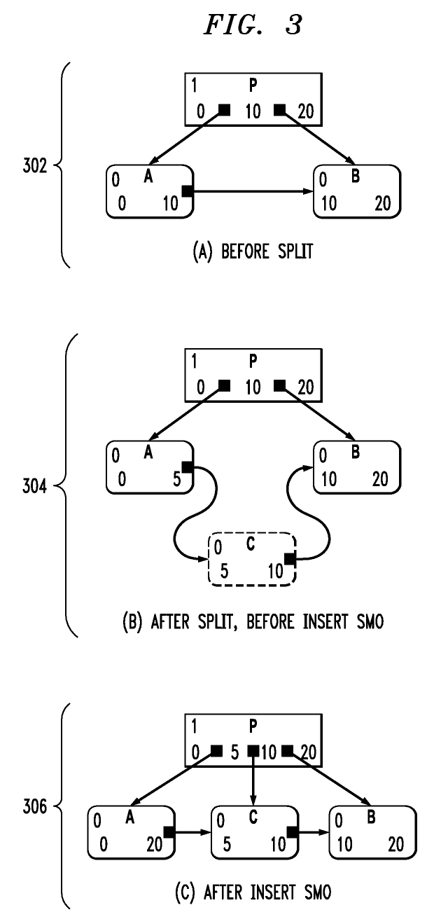

FIG. 3 is a diagram illustrating an insertion operation, according to an embodiment of the present invention. By way of illustration, FIG. 3 depicts the overall sequence of handling a split. 302 illustrates the initial situation, 304 illustrates the state after splitting node A into A and C (but before running InsertSMO), and 306 illustrates the final state after running InsertSMO. As discussed with FIG. 2, the situation in 304 is visible to concurrent B-tree operations.

If the root node splits, one can create a new root node, referring to the split node and its right sibling, and update the root pointer to refer to the new root node. Note that operations that come to the split root node before one adds the new root node still proceed correctly, though they may have to take an immediate move to the right.

An option that can avoid allocating a new node when inserting into a full node is to perform local rebalancing. Recall that one or more embodiments of the invention includes pairs (and the key range associated with a node) that can move only to the right. If an inserted pair overflows its target node, and the target's right sibling has free space, one can move some pairs from the target to the sibling. This can include locking both nodes exclusively. Note that not only do some pairs move, but also some range of key space can get moved from the target to the right sibling as well. This can include using a separate SMO to the parent level to record that adjustment of key space (updating the boundary between the siblings). This is similar to inserting into the parent level after a split, except that it modifies existing information as opposed to adding a new pair and child pointer.

As with insertion, deletion most commonly includes a search followed by an update of one leaf node. For leaves that become under-fill, there are two existing strategies. One strategy rebalances the under-populated leaf by drawing pairs from one (or both) of the leaf's siblings. This can apply in a B-tree of order k if there are still 2×┌k/2┐ pairs left between two adjacent nodes, that is, enough to properly populate both nodes. If there are not enough, then one shifts all the pairs into one of the nodes and deletes the other one. This strategy maintains O(n) space use for the B-tree, necessary for obtaining O(logn) levels and thus O(logn) time for operations.

An alternative strategy is to tolerate under-full nodes, deleting them only when they become entirely empty. One or more embodiments of the present invention use such an approach, for example, to avoid the complex algorithmics of rebalancing. Note that one can also simply rebuild a tree if its space efficiency is too low, although doing so concurrently would require additional coding effort.

One or more embodiments of the invention include pseudo-code for DeleteOp (as illustrated below). Its subtle aspect is the adjustment of the ranges of nodes when a node becomes empty and one wishes to delete it. One can choose to make the range of the empty node also empty (max equal to mm) so that the node can be unlinked and freed later. To do this, one can push the node's range to the right (following the rule that range and pairs move only to the right).

If the empty node is the last one on its level, one can simply leave it. This can result in at most O(logn) space waste, not significant asymptotically (or in practice for trees of any size). Also, if the node's right sibling is also in the process of being deleted, one can search for a node farther to the right until one reaches a node not being deleted. It might seem that threads can race in deleting nodes and pushing range to the right, but because one or more embodiments of the invention retain an X mode lock on the node being deleted until we successfully push its range right, threads cannot pass each other in the pushing process. Rebalancing under-full nodes (if implemented) can proceed similarly, skipping over nodes being deleted to find a suitable node into which to shift pairs (and range). That search can be done within the first atomic block, as noted in the code.

```
boolean DeleteOp (Node start, Pair pr):
  Node here, first, second;
  Node next = start;
  boolean more = false;
  while (true) // loop to find pr’s node
    here = next;
    atomic (here, X)
      if (pr not in range of here)
        next = here.next;
        continue;
      else if (pr not in here)
        // no change required;
        return false;
      delete pr;
      if (here has pairs but is underfull)
        // rebalancing goes here; should search to find
        // the first node to the right that is not being
        // deleted, then atomically shift pairs and range
        // to that node and start a rebalancing SMO at
        // the parent level
      if (here has any pairs || here.next == null)
        return true;
      // starting to delete node here
      here.state = beingDeleted;
      first = here;
      // repeatedly push key range to the right
      boolean more = true;
      while (more)
        atomic (first, X)
          first.max = here.min;
          second = first.next;
          atomic (second, X)
            second.min = here.min;
            more = (second.state == beingDeleted);
          first = second;
  break;
request DeleteSMO(here.level+1, here.min, here, first);
return true;
```

In a worst case, the code above acquires three nodes at once, the node being deleted (here) and a pair of adjacent nodes (first and second) between which one is shifting key range. In the first iteration of the loop above, here and first are the same node. It may be possible to reduce this to two nodes, but it would require relaxing the invariant that key range is always exactly partitioned across a level.

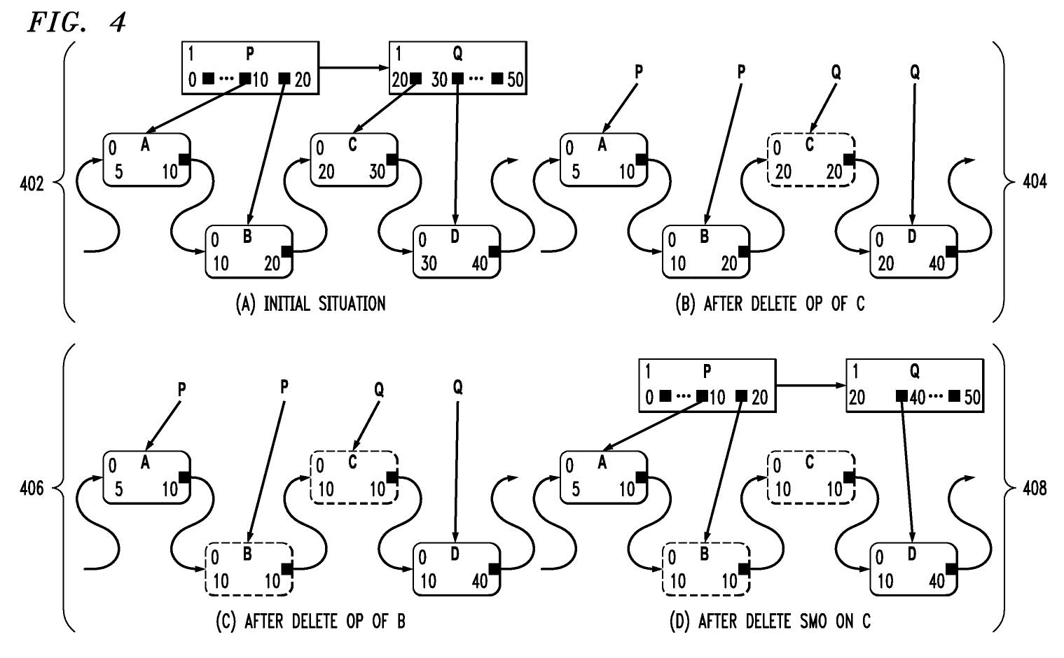

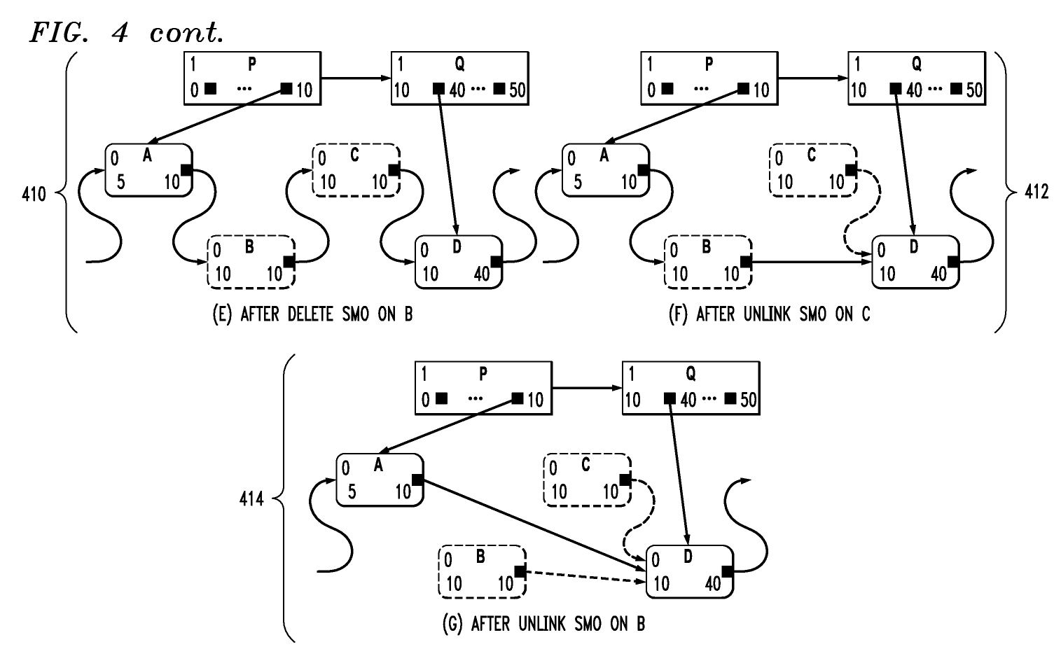

FIG. 4 is a diagram illustrating a deletion operation, according to an embodiment of the present invention. By way of illustration, FIG. 4, in part, depicts the pushing procedure. 402 illustrates an initial state with nodes P and Q at the parent level, and leaves A, B, C, and D. 404 illustrates the situation after DeleteOp makes C empty. C's range has moved to D, and Q will be updated by the deferred DeleteSMO. Similarly, 406 illustrates the situation after DeleteOp makes B empty. Notice how its range is “pushed” through C to D, but updating C's (empty) range on the way.

Concerning rebalancing, if the under-full node's right sibling is too full to receive all of the under-full node's pairs, one can imagine “pulling” pairs from the left sibling. This can be complex because the linked list goes in one direction only. Double linking requires more locking and updates, so it may not be advantageous always. Notice that together an under-full node and a full right sibling still maintain O(n) space usage all together, so in fact “pulling” may not be necessary.

As described herein, in the pseudo-code above, there are occasions where one can request an SMO. That can mean that one can either make a note of the desired SMO and execute it at the end of the current operation, just before returning to the user, or enqueue the SMO for some helper thread to execute on its behalf. The first option can be referred to as synchronous and the second above-noted option can be referred to as asynchronous. Both are deferred, meaning they can be executed after the current operation and start in a situation where the thread is not in an atomic block. Asynchronous SMO execution requires designing a suitable work queuing mechanism, which has the advantage that the number of helper threads constrains the number of concurrent SMOs, and in particular, using a single helper thread guarantees atomicity of SMOs with each other, simplifying implementation. Asynchronous SMO execution reduces user-thread operation times (and variance in those times), while synchronous SMO execution may increase concurrency of SMO execution.

In any case, each SMO must search, to the appropriate level. One or more embodiments of the invention provide a target pair and also the relevant child node(s) and other information. The code illustrated below sketches InsertSMOCore, as would appear inside the ApplyOp pattern. However, before calling Search, the InsertSMO code can check if the level of the requested insert is higher than the root node of the tree (that is, the root just split). In that case, it must create a new node with the two children and given boundary key, and update the root pointer to refer to that new node.

```
void InsertSMOCore (Node parent,
      Pair start, Node child,
      Pair split, Node fresh):
  // here we hold parent in X mode,
  // and start is in parent’s range
  insert split and fresh just after start and child;
  fresh.state = present;
  if (parent overflows)
    do split analogously to leaf level;
    // the next level SMO request looks like this:
    request InsertSMO(parent.level + 1, parent.min, parent,
      newbnd, fresh);
```

In pseudo-code, DeleteSMO is quite similar to Delete (see below). However, after removing the child from the parent's level (which may request an SMO at the grandparent level, etc.), it requests an UnlinkSMO to remove the child from the linked list at its level and attempt to reclaim it. If the child is the first node of its level, then one can skip unlinking. Otherwise, UnlinkSMO searches to find the predecessor of the child being removed. It can proceed similarly to Search and ApplyOp, except that it is trying to find a node whose min is less than the child's min (start in the code below), and in its ApplyOp loop it is trying to find a node whose next is child. One can refer to this node as pred. The pseudo-code for UnlinkCore illustrates the rest. Note, however, that it is possible for child to end up as the first node of its level, even after we request the UnlinkSMO. In this case pred will be null.

```
void DeleteSMOCore (Node parent, Pair start,
      Node child, Node rcvr):
  // here we hold parent in X mode and
  // start is in parent’s range;
  // rcvr, which receives the deleted range,
  // is used for synchronization
  delete start and child from the node;
  child.state = deleted; // will no longer be offered
  if (rcvr is not a child of parent)
    push range from start to the right of parent
  if (parent is underfull or empty)
    proceed similarly as for leaf level
  // may request DeleteSMO to remove
  // parent at grandparent level
  request UnlinkSMO(child.level, start, child, rcvr);
void UnlinkCore (Node pred, Node child, Node rcvr):
  // if pred != null we hold it in
  // X mode, and child == pred.next
  if (pred != null) pred.next = rcvr;
  child.state = unlinked;
```

Returning to FIG. 4, 408 illustrates the situation after the DeleteSMO for C. At that time, Q no longer points to C, but C is still linked at the leaf level. 410 illustrates the situation after the DeleteSMO for B. Similarly, P no longer points to B, but B is still linked. Also, 412 and 414 show the situations after the UnlinkSMO for C and B, respectively.

One or more embodiments of the invention include ordering restrictions on executing SMOs. For example, if a node splits, and then all of the fresh node's pairs are deleted, one might have concurrent deferred SMOs for the split that introduces the new node and for the node's deletion. A drastic solution would be to execute SMOs one at a time in the order they were requested. However, this would be a concurrency bottleneck and is overly restrictive, since many SMOs can proceed at the same time safely. An important insight to solving this problem is that one needs to execute two SMOs in the order in which they were requested only if their affected key ranges overlap. SMOs for non-overlapping ranges can proceed concurrently (modulo atomicity of updates to parent-level nodes).

One or more embodiments of the invention use the child-level nodes as surrogates for their ranges. For example, an SMO can pertain to one or more affected nodes if their range is involved. Thus, an InsertSMO pertains to the node that was split (child) and to the node introduced by the split (fresh), and a DeleteSMO pertains to the deleted node (child) and the node to which it ultimately shifted its key range (rcvr). Likewise, an UnlinkSMO pertains to child and rcvr.

When one requests an SMO, one obtains a ticket for each node to which the SMO pertains. Here is how tickets work, in accordance with one or more embodiments of the present invention. Each node has two ticket counters, nextTicket and nextServed, each starting at 0. To get a ticket, while holding the node in X mode, one reads the value of nextTicket, and then increments it. An SMO is ready if the nextServed values in each node to which the SMO pertains match the tickets that one obtained when one requested the SMO. One can begin to execute an SMO after it is ready, and when an SMO completes, it increments nextServed in the nodes to which it pertains. Checking whether an SMO is ready can be done having acquired the relevant objects in at least S mode, though an implementation may be able to use some form of volatile memory read instead. Likewise, if an SMO does not need to acquire a pertinent object in X mode, when done it may be able to use an atomic increment instruction on nextServed, avoiding locking. These, however, are just refinements to the safe strategy of accessing and updating the ticket counters only under the proper lock.

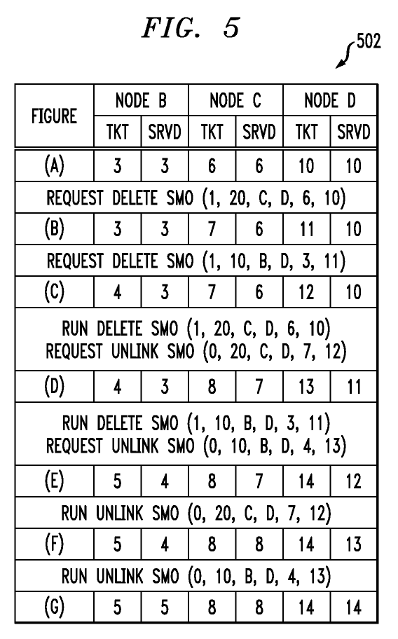

Additionally, FIG. 4 illustrates ordering constraints. Assumed that a DeleteOp call requested a DeleteSMO for C, and then another DeleteOp call requested a DeleteSMO for B. Ticket ordering on D forces the two DeleteSMOs to run in that order at the parent level. They take new tickets on D for the two UnlinkSMOs, so those also run in the order C then B. FIG. 5 is a diagram illustrating ticket sequencing 502 for FIG. 4, according to an embodiment of the present invention. By way of illustration, FIG. 5 depicts details, assuming some starting ticket numbers, and adding ticket numbers to SMO requests. One can abbreviate nextTicket as tkt and nextServed as srvd, and show the ticket situation before and after each SMO-related operation. Running a DeleteSMO involves requesting an UnlinkSMO as part of it, so those two appear together.

A cursor caches information about a node, and the path from the root to that node, in the hope of speeding up later operations, such as FetchNext during a sequential scan. If a sequence of operations has some degree of locality, then cursors will likely speed up the sequence at the cost of additional bookkeeping. A cursor may be used for accessing leaf nodes or for accessing interior nodes when performing SMOs or needing to search further.

A cursor includes, for each level of the tree, the node most recently traversed at that level. New cursors start in an uninitialized state. Using an uninitialized cursor requires traversing from the root of the tree, but will initialize the cursor for each level of tree accessed during the search. Considering a Search routine as described herein, the node that should be entered into a cursor when starting from the root is the node whose key range includes the key for which we are searching.

When using an initialized cursor to search for a given pair p at a given level (for example, leaf level), one examines the node that the cursor records for that level. If the cursor has no node for that level, or if the pair p lies outside the range of the node, one examines the node remembered by the cursor for the next higher level. If one finds a node whose range contains p, one proceeds from that point as in Search. It is possible that none of the nodes includes p (the tree may have grown in height), in which case one treats the cursor as uninitialized and starts from the root. As one finds nodes that include p, one records them in the cursor for future use.

A FetchNext can proceed slightly differently from an ordinary search, as it looks for a node that includes p but whose max is strictly >p. It may still have to move right from that node, but it cannot distinguish that case without inspecting the pairs in the node. In such cases of sequential access requiring a move to the right, one typically moves just one node to the right, and it is sometimes necessary.

Optionally one may cache additional information in cursors to speed operations more. For example, one may record the min and max of each node recorded in the cursor to reduce probing nodes that are not likely to help. The utility of this depends on locking costs, etc. Another possible improvement is to record in the cursor with each node the pair most recently accessed at that node, and the index of that pair within the node's array of pairs. To determine whether the index is valid, one can add a field to each node referred to as modCount, which one can increment whenever one changes the set of pairs in a node. The cursor samples and saves modCount when saving the pair and index information. Thus, if the saved modCount matches, then one can use the index and avoid a binary search for the pair. A benefit of cursors is likely to be reducing the number of nodes accessed, the number of binary searches performed, etc.

Consider a node that becomes empty and is unlinked from its level's linked list. One might think that one could reclaim that node immediately. In fact, it is possible that there are active threads that will still traverse it, and cursors may also refer to it. As such, one or more embodiments of the invention reclaim nodes using reference counting. For example, one can maintain in each node the current number of references to the node, both from other nodes and from threads and cursors. However, such a strategy requires incrementing and decrementing reference counts even for read-only search operations. So the actual reference counting scheme provided in one or more embodiments of the invention is deferred reference counting. In such a scheme, one maintains in the node a count only of the number of references from other nodes, a quantity that does not change frequently. A node is certainly not eligible from reclamation until this reference count is 0. Notice that unlinked nodes can refer to each other and to linked nodes, so it is not obvious when the count will become 0. But one needs to prevent reclaiming the node if there are thread or cursor references to it, as described herein.

For each thread, and for each level of a cursor, one can assign an identifier (id) that is unique among all the ids currently assigned. It is perhaps easiest to imagine the id as a direct index into a single flat array, which one can refer to as the dynamic reference table. In practice, one preferably needs a scheme that is relatively fast at assigning currently unused ids and at getting and setting the node associated with an id.

Whenever a thread holds a reference to a node that it has not currently acquired (in either S or X mode), the thread stores a copy of the node reference into the thread's unique slot in the dynamic reference table. Likewise, when the thread is done using that reference, it clears the slot. Similarly, when caching a node reference in a cursor, one can store a copy of the node reference into the unique table slot assigned to that level of that cursor. One can clear slots associated with cursors when reinitializing or destroying the cursor. If it were important, it might also be possible for an asynchronous thread to clear information in a cursor, but cursors are customarily private to threads and thus not requiring synchronization for them to access. Allowing other threads to access cursors would impose additional synchronization requirements.

When a node's reference count becomes 0, one can scan the dynamic reference table. This scan may be done only periodically by a background thread, if desired. If no slots refer to the node, one can reclaim it. This works because once one unlinks the node, no additional threads or cursors can obtain references to the node. If some table slot refers to the node, one cannot reclaim it. One can manage the deferred reclamation of these nodes by entering them into a watched node table, along with a record of the table slot(s) that refer to the node. Periodically, one can check to see if any watched node's slots no longer refer to the node. Eventually, there will be no such slots and one can reclaim the node.

Additionally, one may need some way of indicating that a thread or cursor will no longer use its dynamic reference table slots, so that the table space can be reused or compacted. One or more embodiments of the invention handle that by requiring threads to connect to a tree (in order to obtain a table slot) and later to disconnect from it (freeing the slot). Because threads do not retain node references between B-tree operations, the connect/disconnect protocol can be associated with accessing any B-tree, not with each one individually. Likewise, one can also require cursor finalization, which will release the associated table slots.

One or more embodiments of the invention assume atomic blocks (locks) that protect one B-tree node at a time, referred to herein as fine-grained locking. For those actions that require atomic access to two or three nodes at once, one can employ nested atomic blocks. In principle, a fine-grained approach will yield the highest concurrency (among approaches that lock only whole nodes, as opposed to fields of nodes, etc.). However, the highest concurrency may not give the highest throughput, because locking overhead can be significant. In fact, there are reasons to believe that in multi-core systems, locking overhead will be relatively higher than in previous systems.

In B-trees, SMOs occur only a fraction of the time that leaf modifications do, and become progressively rarer at higher levels of the tree. As such, one or more embodiments of the invention use fine-grained locking only for levels at or below a chosen threshold level of a given tree. Also, one or more embodiments of the invention offer the following choices for fine-grained locking: none (one lock for the whole tree), leaves only, or all nodes fine-grained.

For each level of a tree, there is a first node at that level. Consider the nodes at level n referred to by level n+1 (their parents), and all the nodes reachable from these level n nodes by following next pointers. These are exactly the nodes of level n whose state is not unlinked or unrooted. One can refer to these as linked nodes. One can verify that nodes in states present and beingDeleted have a parent referring to them. Nodes in state beingAdded do not have a referring parent, but a referring left sibling that is reachable from the parent level, and will remain so (because of SMO ordering) at least until the new node is added at the parent level. Nodes in state deleted, likewise, have a reachable left sibling (because they were not the first child referred to from the parent level). Also, unlinked nodes are not reachable from the parent level or from any linked node. The unroofed state can be used for an old root node when the tree shrinks in height. It is not reachable from the root, but continues to refer to the first node of the next lower level. Unlinked nodes continue to refer to their former sibling.

Additionally, the nodes of a level exactly partition the key-value pair space from [symbol] −∞,−∞ [symbol] to [symbol] +∞,+∞ [symbol] . The initial node can start that way, and each split maintains the property. When deleting a node, one can make its range empty (but in sequence), pushing its range to the right. Thus, when one unlinks a node in the middle of a level, one maintains the invariant. Likewise, if one deletes a node at the left end of a level, because its range is empty and starts with [symbol] −∞,−∞ [symbol] , its right sibling also starts with [symbol] −∞,−∞ [symbol] .

Also, note that the min and max of a node never increase. A split decreases the max of the splitting node. A delete also decreases the max of the node being deleted, and the pushing right of its range decreases its sibling's min. Further, pushing decreases one node's max and the next node's min. No node will ever have max <min, and the leftmost node's min will always be [symbol] −∞,−∞ [symbol] and the rightmost node's max will always be [symbol] +∞,+∞ [symbol] (it never decreases).

Also, because of the non-increasing min and max of nodes, “out of date” references from parents or non-linked nodes can refer only to nodes whose range begins no higher than what the referring node might assume. As such, when a search proceeds to level n searching for a particular pair, it will always arrive at or to the left of the proper node. If it is to the left, it can search to the right. It need not lock nodes (in lock coupling style) while doing this, because the referent node's range also obeys the non-increasing property.

Additionally, one can make the following claims concerning SMOs and their ordering. The left sibling O of a new node N must be inserted in the parent level before N is inserted. This is because the ticket from O for adding O is strictly less than the ticket from O for adding N. Also, the right sibling N must be inserted in the parent level before O is deleted. Again, this is because the ticket from O for adding N must be strictly less than the ticket from O for deleting O. Further, a being-deleted node D must be deleted before the node R receiving its range is deleted. This is because the ticket from R for deleting O will be strictly less than the ticket from R for deleting R.

When a node U becomes unlinked, its range receiving node R must be linked. This is because when the UnlinkSMO is requested, R is not yet deleted, so the ticket from R for unlinking U must be less than the ticket from R for unlinking R. Also, when U becomes unlinked, its range receiving node R will be its right sibling. U is deleted after all the nodes between U and R, and thus it will be unlinked after those nodes are unlinked. Because they are unlinked, there is no node between U and R, and hence, R is U's right sibling. Additionally, if in UnlinkSMO the predecessor pred is not null, then pred is linked and is the left sibling of child. The fact that pred is linked follows from the fact that a search found it (search can find only linked nodes). It is the left sibling because it refers to child. These facts do not come from ticket ordering of UnlinkSMO, but from the particular search it does. If child is first on its level, or becomes so during the search, pred will be null.

At a given level, when searching for pair p in a parent node whose range includes p, one will choose the child c that apparently contains p. When one arrives at c, it may have a different range from what was seen in the parent, but it can only be lower. If c's max is ≦p, one can proceed to the right. In between releasing c (in S or X mode) and acquiring its right sibling r, r's range could become lower, but again, one can simply keep searching. If a search terminates, it gives the correct answer, and that termination is a problem only if other threads insert new pairs more rapidly than the searcher can skip over them. It is also possible that c is unlinked by the time one examines it. However, it maintains a next pointer to a node whose min is≦the min of c (which equals the max of c). Again, one can find p by proceeding to the right, even though c was unlinked. The same holds going to the only child of an unrooted former root node.

Also, the non-split case follows from correctness of search. The split case maintains the invariants that allow search to work. In a sense, the InsertSMO is not necessary for correctness, but it is necessary for the tree to stabilize to O(logn) cost. The SMO ordering constraints insure that operations pertaining to ranges containing any specific key k (splitting, balancing, deleting (merge of ranges), etc.) execute in the same order at the parent level as they do at the child level. Therefore, since k is always in the range of some node at the child level, not only will it be in the range of some node at parent level, in an idle tree the parent level will indicate the exact child whose range contains k.

The non-SMO case again follows from correctness of search. Otherwise, let D be the node to be deleted and R the node receiving its key range. The X mode lock one keeps on D prevents any pushing of range from the left of D. The nodes between D and R, which are being deleted, have already pushed their range right (ultimately to R). They will be deleted from the parent level by the time this DeleteSMO executes, and they will be unlinked from the child level by the time the UnlinkSMO for D runs. So when the SMOs run, R is D's right sibling and is still linked (even if D is the first node of its level, etc.).

One or more embodiments of the invention implement the algorithm in C using p-threads as the threading library. Such an implementation can have different components. For example, one can have a multi-threaded workload generator that emulates a concurrent user workload including concurrent insert, delete, and search operations. Additionally, one can have a workload manager that converts user requests into tree operations and also manages auxiliary functions such as cursors and asynchronous SMO threads (when supported). Further, an implementation can have the core Blink-tree component that implements a non-unique key-value pair index.

Upon the first request from any thread, the workload manager registers the thread and assigns it a cursor. The cursor data structure is a stack whose size is bound by the maximum depth of the tree. Initially it contains only one entry, which refers to the Blink-tree root. The workload manager can invoke the corresponding Blink-tree operation with the cursor top as the starting point of the tree operation. One or more embodiments of the invention can also implement a non-cursor based implementation where each tree operation always starts from the tree root.

Also, one or more embodiments of the invention can opt, for example, not to support rebalancing, and thus delete a node only when it becomes empty. One can implement both synchronous and asynchronous SMO processing. For asynchronous processing, one uses a single SMO processing thread, which simplifies the queuing protocol. One or more embodiments of the invention support atomic blocks using compare-and-swap (CAS)-based multiple-reader, single-writer read-write locks. A writer can wait for all concurrent readers or any current writer to complete. A new reader can also wait if there is a current writer.

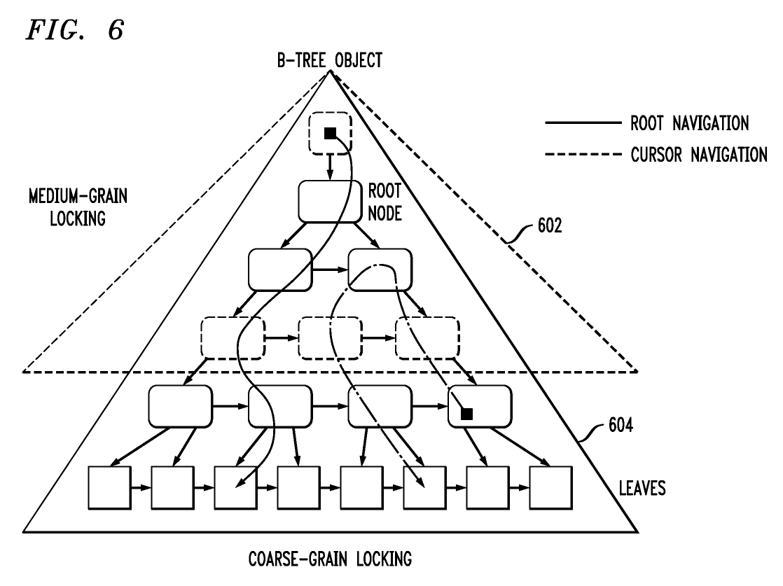

One or more embodiments of the invention also support three lock granularities: coarse, medium, and fine. In the coarse-grained implementation, an operation locks the entire tree. Search operations lock it in S (read) mode, whereas insert, delete, and SMO operations lock it in X (write) mode. In the medium-grained implementation, one can lock the internal (non-leaf) sub-tree separately from the leaves (see, for example FIG. 6). FIG. 6 is a diagram illustrating granularities of atomic blocks, according to an embodiment of the present invention. By way of illustration, FIG. 6 depicts a cursor navigation component 602 and a root navigation component 604. In both cases, the medium-grained locking locks only the internal (non-leaf) sub-tree, whereas the coarse-grained locking locks the entire tree.

While executing search, insert, and delete operations, the navigation phase holds the lock on this region in S mode, while SMO operations lock it in X mode. One can lock leaf nodes individually in either S or X mode as appropriate. Further, in the fine-grained version, one can lock each tree node, leaf and non-leaf, individually in S or X mode. Note that careful implementation of the core tree operations into three logical phases (search, leaf, SMO) enables one to use the same code for all three granularities.

By way of example, the medium-grained implementation can execute fewer lock operations than the fine-grained implementation, Moreover, in steady state, the number of SMOs is not significant, which reduces contention on the internal nodes of the tree (that is, the higher you are in the tree, the lower the frequency of X mode locking).

As described herein, one or more embodiments of the invention design and implement a highly concurrent B-link-tree using atomic blocks. Additionally, the techniques described herein support multiple lock granularities and cursors, as well as obtain high concurrency through both finer-grained locking and deferring structure modifying operations.

Additionally, one or more embodiments of the present invention include concurrent operations on a B-link tree implemented as non-nesting atomic sections. These sections can be implemented either using locks or via transactional memory. Also, structured modifications to the tree are always deferred and can be executed asynchronously. Further, in one or more embodiments of the invention, the granularity of the atomic region is adjustable and varied from the entire tree to a single node.

The techniques described herein support high concurrency while using atomic blocks in an implementation. Atomic blocks impose a discipline of static declaration of regions in which the system enforces atomicity of accesses. However, their static structure precludes lock coupling down through the levels of the tree, the usual method for traversing concurrent B-trees. One or more embodiments of the invention use atomic blocks, for example, because of their software engineering advantages over unstructured use of locks. For example, one or more embodiments of the invention are deadlock-free.

In the techniques described herein, structure modifying operations (SMOs), such as B-tree node splits, occur as separate deferred, even asynchronous, operations at each affected level. This can increase concurrency and lead to interesting data structure invariants and traversal algorithms. One or more embodiments of the invention include a fine-grained concurrency approach that locks as few nodes as possible at a time. The techniques described herein also present coarser-grained strategies, which trade off locking overhead versus maximum concurrency. Additionally, one or more embodiments of the present invention further support cursors, which avoid traversing the tree as much when a series of operations has locality.

Further, as described herein, one or more embodiments of the invention use atomic blocks, deferred structure modifying operations, fine-grained locking, adjustable lock granularity, and support for cursors.

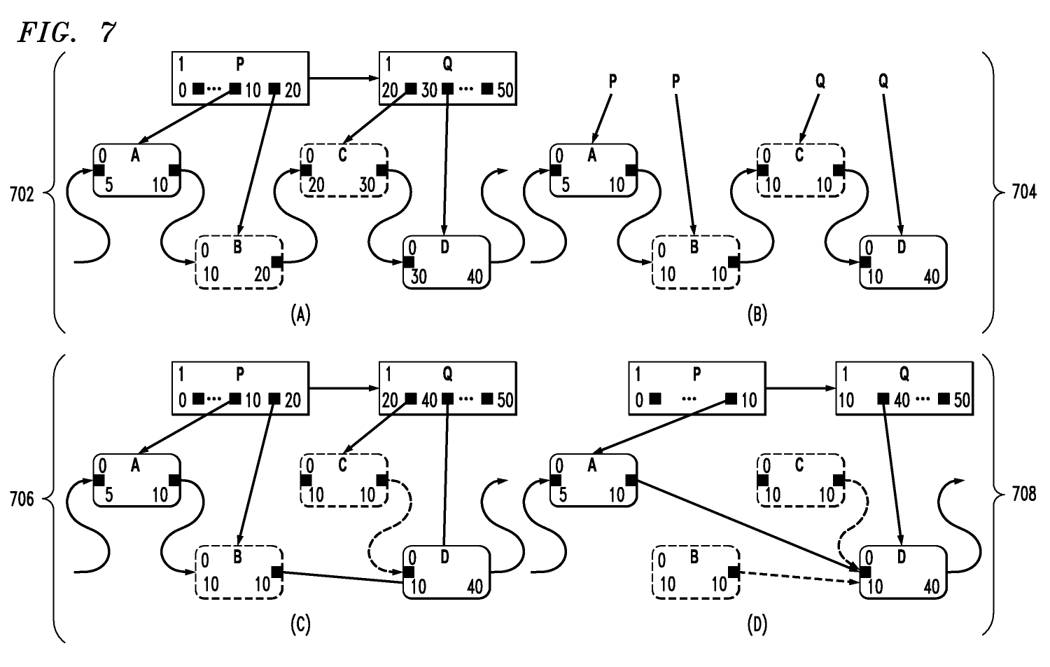

FIG. 7 is a diagram illustrating the delete operation on a concurrent B-link tree, according to an embodiment of the present invention. Component 702 represents the state when nodes B and C are marked for deletion. Component 704 denotes the state when the ranges of nodes B and C are updated. Component 706 represents the state when node C is disconnected and its parent's (node Q) range is updated by a SMO execution, and component 708 represents the state when the node B is disconnected and its parent node (node P) is updated.

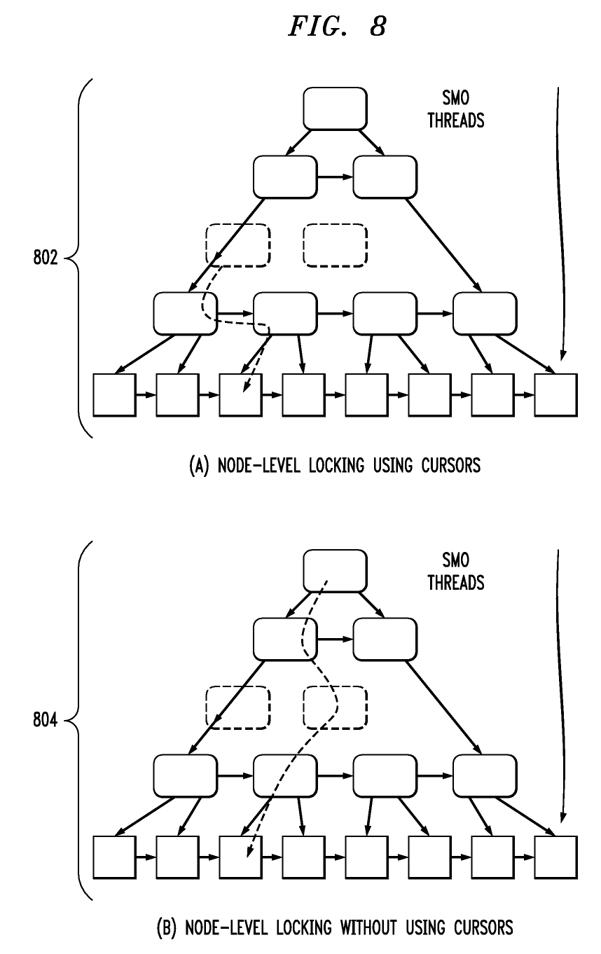

FIG. 8 is a diagram illustrating the use of cursors in a concurrent B-link tree, according to an embodiment of the present invention. By way of illustration, component 802 depicts node-level locking using cursors and component 804 depicts node-level locking without using cursors. More specifically, component 804 illustrates the scenario when a cursor caches the previous navigational pattern and starts the navigation for a new request from the last point of previous traversal, and component 802 represents the case when every request initiates a traversal from the root node.

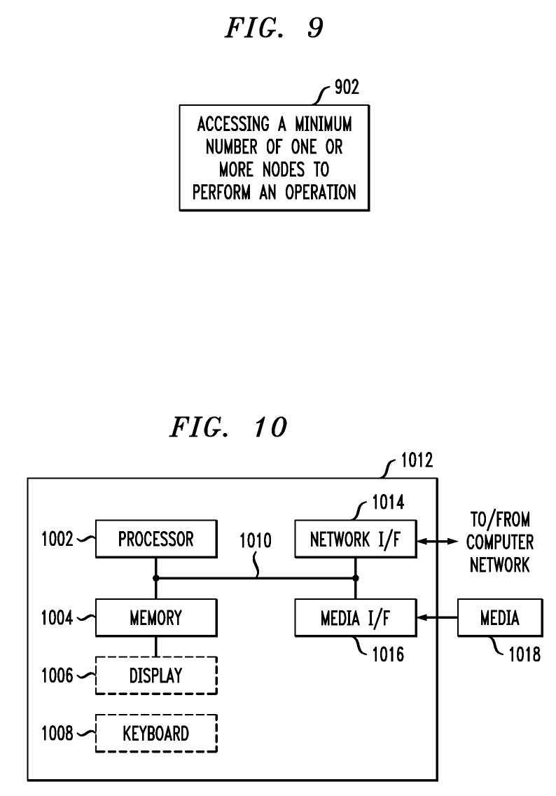

FIG. 9 is a flow diagram illustrating techniques for providing maximal concurrency while ensuring no deadlock in a tree structure, according to an embodiment of the present invention. Step 902 includes accessing (for example, automatically) a minimum number of one or more nodes to perform an operation. Accessing can include, for example, locking a node for reading or for writing, accessing a node using a transaction in the transactional memory sense, etc. Accessing a minimum number of one or more nodes to perform an operation can include, for example, accessing one node at a time to perform a search, an insertion and/or a deletion, wherein the search, insertion and/or deletion do not need to modify the tree structure.

Also, accessing a minimum number of nodes to perform an operation can include accessing two or more nodes at a time to modify the tree structure. Additionally, the beginning and end of periods of such access are described herein. Accessing two or more nodes at a time can include, for example, accessing (atomically) two or more nodes at a same level of the tree structure, and/or accessing two or more nodes in a left-to-right order, which guarantees freedom from deadlock.

Accessing a minimum number of nodes to perform an operation can additionally include using a cursor. Using a cursor can include, for example, the following. Rather than starting at the top of the tree, cursors can start somewhere else, typically the bottom of the tree. Searching in existing approaches starts with the root (top). Cursors may first work up some levels of the tree, while existing approaches proceed down from the root. Also, cursors affect retention of nodes that are empty and otherwise reclaimable.

Further, accessing a minimum number of nodes to perform an operation can include supporting a single granularity scheme (such as, for example, one lock on the upper layers of the tree and individual locks on leaves (or some fixed number of lower levels)), choosing granularity when creating a new tree, and/or choosing granularity during performance of an operation. Lock granularity can relate to transactional access in such a way that a coarser (that is, bigger) lock corresponds to a larger and/or longer transaction.

Additionally, as described herein, a transactional implementation can inherently avoid deadlock (a property of transactions), and can change the order of some steps of the algorithm and obtain some simplifications.

The techniques depicted in FIG. 9 can also include deferring one or more parts of one or more structure modifying operations (SMOs) to gain maximal concurrency and obtain the property of locking (that is, acquiring) nodes only at one level at a time. Deferring of SMOs can include, for example, deferring one or more parts of one or more SMOs synchronously (that is, using the same computation resource (thread of execution) as the operation that caused them) and/or deferring one or more parts of one or more SMOs asynchronously (that is, using other threads for that purpose. For example, asynchronous processing could use one thread, or multiple threads, and could adaptively determine the resources to apply so as not to have a large backlog of pending operations).

Also, the techniques depicted in FIG. 9 can include, when deleting one or more pairs in nodes, marking the pairs as deleted without physically removing the one or more pairs. By way of example, if a node fills up, one might physically delete such marked pairs and get their space back for new pairs. There are advantages to such marking. For example, it reduces the work for most deletion operations, and can reduce the work for insertions (an insertion need only slide pairs over up to the next deleted pair). This can improve concurrency. Also, it reduces the number memory words affected by a deletion, an important consideration in the transactional memory case. Likewise, it can reduce the number of memory words affected by an insertion.

Additionally, in the absence of continuing interference from other operation requesters, a given operation will eventually complete. One or more embodiments of the present invention include operations that can complete even in the presence of arbitrary interference (the interfering operations might be delayed, but would also complete, and there would be stronger restrictions on the order in which things happen).

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 10, such an implementation might employ, for example, a processor 1002, a memory 1004, and an input and/or output interface formed, for example, by a display 1006 and a keyboard 1008. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 1002, memory 1004, and input and/or output interface such as display 1006 and keyboard 1008 can be interconnected, for example, via bus 1010 as part of a data processing unit 1012. Suitable interconnections, for example via bus 1010, can also be provided to a network interface 1014, such as a network card, which can be provided to interface with a computer network, and to a media interface 1016, such as a diskette or CD-ROM drive, which can be provided to interface with media 1018.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 1018) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 1004), magnetic tape, a removable computer diskette (for example, media 1018), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 1002 coupled directly or indirectly to memory elements 1004 through a system bus 1010. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 1008, displays 1006, pointing devices, and the like) can be coupled to the system either directly (such as via bus 1010) or through intervening I/O controllers (omitted for clarity).

Network adapters such as network interface 1014 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, concurrent operations on a B-link tree implemented as non-nesting atomic sections.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for providing maximal concurrency while ensuring no deadlock in a tree structure, comprising accessing a minimum number of one or more nodes to perform an operation.

2. The method of 1, wherein accessing a minimum number of one or more nodes to perform an operation comprises accessing one node at a time to perform at least one of a search, an insertion and a deletion, wherein the at least one of the search, insertion and deletion do not need to modify the tree structure.

3. The method of 1, wherein accessing a minimum number of one or more nodes to perform an operation comprises accessing two or more nodes at a time to modify the tree structure.

4. The method of 3, wherein accessing two or more nodes at a time comprises accessing two or more nodes at a same level of the tree structure.

5. The method of 3, wherein accessing two or more nodes at a time comprises accessing two or more nodes in a left-to-right order.

6. The method of claim 1, further comprising deferring one or more parts of one or more structure modifying operations (SMOs).

7. The method of claim 6, wherein deferring one or more parts of one or more SMOs comprises at least one of deferring one or more parts of one or more SMOs synchronously and deferring one or more parts of one or more SMOs asynchronously.

8. The method of claim 1, wherein accessing a minimum number of one or more nodes to perform an operation comprises using a cursor.

9. The method of claim 1, wherein accessing a minimum number of one or more nodes to perform an operation comprises at least one of supporting a single granularity scheme, choosing granularity when creating a new tree, and choosing granularity during performance of an operation.

10. The method of claim 1, further comprising, when deleting one or more pairs in one or more nodes, marking the one or more pairs as deleted without physically removing the one or more pairs.

11. A computer program product comprising a computer readable medium having computer readable program code for providing maximal concurrency while ensuring no deadlock in a tree structure, said computer program product including:
computer readable program code for accessing a minimum number of one or more nodes to perform an operation.

12. The computer program product of claim 11, wherein the computer readable code for accessing a minimum number of one or more nodes to perform an operation comprises:
computer readable program code for accessing one node at a time to perform at least one of a search, an insertion and a deletion, wherein the at least one of the search, insertion and deletion do not need to modify the tree structure.

13. The computer program product of claim 11, wherein the computer readable code for accessing a minimum number of one or more nodes to perform an operation comprises:
computer readable program code for accessing two or more nodes at a time to modify the tree structure.

14. The computer program product of claim 11, wherein the computer readable code for accessing a minimum number of one or more nodes to perform an operation comprises:
computer readable program code for using a cursor.

15. The computer program product of claim 11, wherein the computer readable code for accessing a minimum number of one or more nodes to perform an operation comprises:
computer readable program code for at least one of supporting a single granularity scheme, choosing granularity when creating a new tree, and choosing granularity during performance of an operation.

16. An apparatus for providing maximal concurrency while ensuring no deadlock in a tree structure, comprising:
a memory; and
at least one processor coupled to said memory and operative to:
access a minimum number of one or more nodes to perform an operation.

17. The apparatus of claim 16, wherein in accessing a minimum number of one or more nodes to perform an operation, the at least one processor coupled to said memory is further operative to:
access one node at a time to perform at least one of a search, an insertion and a deletion, wherein the at least one of the search, insertion and deletion do not need to modify the tree structure.

18. The apparatus of claim 16, wherein in accessing a minimum number of one or more nodes to perform an operation, the at least one processor coupled to said memory is further operative to:
access two or more nodes at a time to modify the tree structure.

19. The apparatus of claim 16, wherein in accessing a minimum number of one or more nodes to perform an operation, the at least one processor coupled to said memory is further operative to:
use a cursor.

20. The apparatus of claim 16, wherein in accessing a minimum number of one or more nodes to perform an operation, the at least one processor coupled to said memory is further operative to:
at least one of support a single granularity scheme, choose granularity when creating a new tree, and choose granularity during performance of an operation.
